(19) United States
(12) Patent Application Publication
(10) Pub. No.: US 2005/0216391 A1
(43) Pub. Date: Sep. 29, 2005

(54) System and method of on-line merchandising

(76) Inventor: Serge Tews, Miami, FL (US)

Correspondence Address: MALLOY & MALLOY, P.A., 2800 S.W. Third Avenue, Historic Coral Way, Miami, FL, 33129, US

(21) Appl. No.: 10/810,155

(22) Filed: Mar. 26, 2004

(51) Int. Cl. G06F 17/60

(52) U.S. Cl. 705/37

(57) ABSTRACT

A system and method for on-line merchandising utilizing a gaming format which includes the on-line purchase of a pre-determined number of bids each representing an equal opportunity for being awarded preselected merchandise. Any customer having purchased one or more bids from a bid pool will be awarded the merchandise at a reduced price by holding a randomly selected winning bid. An included distribution format comprises the additional awarding of preselected merchandise, or a substantial equivalent thereof, to any customer having purchased a quantity of bids with a collective monetary value which is at least substantially equal to the purchase price of the preselected merchandise.

### BACKGROUND OF THE INVENTION

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

1. Field of the Invention

This invention relates to a system and method for distributing preselected merchandise to bid purchasing customers by means of a lottery, raffle or like gaming format, at a potentially reduced price but at no more than a cost to the customer which is substantially equal to the full purchase price of the preselected merchandise.

2. Description of the Related Art

It is widely accepted that the most rapidly growing commercial segment of today's economy is merchandising products and services over public communication networks and specifically the Internet. Using the Internet, the annual increase in electronic commercial transactions has amounted to millions of dollars for each of the past few years. The advantage of computer-based merchandising systems using the Internet is obvious when compared to more conventional types and areas of merchandising.

By way of example, prior to the development and popularity presently enjoyed by computer-based merchandising systems, customers were typically required to visit specific physical locations such as retail, wholesale and like distribution outlets. The disadvantages and problems associated with such conventional techniques involved access to a limited number of customers which could physically visit an outlet. Such restrictive exposure is based either on the geographical location of the outlet and/or the size and/or distribution facilities associated therewith. In addition, conventional distribution outlets, because of limited physical facilities, normally carry a specialized and/or relatively small selection of products. Such limitations sometimes results in the customers having to visit a plurality of such outlets in order to be exposed to a full range of products, services, etc. Some of the noted exceptions to the limited merchandise availability of such outlets is the conventional “supermarket” grocery store and other expansive facilities maintained by extremely large retailers commonly known to the consuming pubic. However, even such exceptions have limitations which could only be overcome by the establishment of a plurality of outlets or a “chain” of such outlets located throughout one or more geographical areas.

In contrast to the known techniques and physical limitations of conventional distribution outlets, as set forth above, Internet based merchandising systems can reach literally millions of people and offer an almost inexhaustible variety of products, services and other valuable merchandise. Moreover, advantages to the customer while shopping on-line include access to thousands of electronic vendors from the convenience of a customer's home or other area where Internet access facilities are located. However, perhaps one disadvantage associated with on-line merchandising, at least from the point of view of a vendor, is the rapidly escalating competitive nature of computer-based merchandising systems as evidenced by the extremely large number of on-line vendors. As a result, many on-line vendors have resorted to auctions, lotteries, raffles or like electronic gaming formats which appear to present the customer with an opportunity to obtain the desired merchandise at a reduced cost.

Also, such gaming formats, procedures, systems, etc., may add to the excitement experienced by the consuming public when attempting to obtain desired products, services, etc. By way of example only, one type of computer-based auction for the sale of products utilizes e-mail sent over the Internet. This type of merchandising system typically involves bidders or participants in the auction sending e-mails to the auction site or controller with details of a specific bid and identity of the bidder. The bid details are posted on the web site of the auction and are available to other participants. The auction process is usually conducted over an extended time period of several days, wherein at the end of the time period the product is sold to the highest bidder. Advantages of systems of this type include the lack of complexity in Internet participation, especially where e-mail is used to communicate with the auction site. However, related disadvantages include a prolonged period of time for conducting the auction and the resulting frustration especially when the auction is frequently decided in the last few minutes before the bidding closes.

In addition to the above, at least one currently popular on-line merchandising entity is reportedly encountering problems which may affect its growth and expansion opportunities. More specifically, large corporations, retailers, suppliers, etc., desirous of merchandising large volumes of a specific product line have discovered that an on-line auction facility may not be the most effective way of distributing such merchandise to the consuming public. Attempts to sell significant quantities of the same or similar products such as cameras, laptops, desktop computers or a variety of other look-alike items resulted in the price of the item crashing due to the relatively limited number of buyers interested in the same product line as compared to the large quantity of the same merchandise offered. Therefore, distinct disadvantages of conventional on-line auction or other gaming format sites include supply and demand problems manifested in the inability to merchandise large quantities of the same or similar products.

Generally speaking, a typical auction procedure involves a seller providing information about an item of merchandise as well as the parameters with which the auction procedure must comply, including a low initial starting or bidding price. Bidding proceeds as the customers incrementally raise the bid price. At the close of bidding, the high bidder obtains the product for the amount bid, which the customer hopes will be below the normal purchase price of a given product or service. While it is recognized that the customer controls the bidding price, it is not unusual for excitement to control the customers to the extent that the bidding price reaches or exceeds the normal retail purchase price resulting in little or no savings to the winning customer. In spite of certain disadvantages, it is understandable that computer-based auctions are popular to both the seller and the buyer. Moreover, a seller can be relatively certain of reaching a large group of motivated customers and the buyer can often obtain a product at a favorable price. The competition between bidding customers is also a frequently attractive feature of the on-line auction.

Based on the above, it is believed that on-line merchandising can still be improved and many of the well recognized disadvantages thereof can be overcome. Moreover, an improved, computer based merchandising system and attendant method may be more effective by providing customers with an opportunity to obtain preselected merchandise at a reduced price, while guaranteeing that the customer will obtain the merchandise at a cost no greater than the normal purchase price of the merchandise. Accordingly, the fear of a customer losing the money invested in purchasing losing bids is eliminated.

### SUMMARY OF THE INVENTION

The present invention is directed to a system and method of on-line merchandising of a variety of products, services and other value-based merchandise by implementing a raffle, lottery, auction or like gaming type format. Moreover, the preferred embodiments of the present invention provide customers the opportunity to obtain desired merchandise at a reduced price. In addition, the customer is provided with the benefit of an added guarantee that continuing in the subject gaming format will result in the award of the merchandise at a cost which is substantially equal to the original purchase price of the preselected merchandise. Therefore, the present invention offers the convenience commonly associated with on-line merchandising and/or computer-based systems, wherein the Internet serves as the primary basis of communication and access for implementation thereof. Concurrently, the various preferred embodiments of the present invention incorporate the excitement and pricing benefits normally associated with a raffle, lottery or auction-type format.

While the specifics of the merchandising system and method of the present invention will be described in greater detail hereinafter, it is emphasized that the terms “raffle”, “lottery” and/or “auction” may be used herein interchangeably and any and/or all of these terms, as used, is not meant to be interpreted in a limiting sense. The applicable nature of such terminology is at least partially based on the present invention providing the opportunity of a plurality of customers to purchase one or more bids. Further, each of the bids represents an equal opportunity for the customer to be awarded preselected merchandise with which the bid is associated. However, unique to the particular gaming environment incorporated within the present invention is the opportunity for each of the plurality of bid-purchasing customers to be awarded the preselected merchandise at a potentially reduced price with the alternate guarantee of obtaining the preselected merchandise at a cost which is substantially equal to the original purchase price of the preselected merchandise.

More specifically, the present invention comprises a marketplace which may be “visited” by on-line access utilizing any computer, processor and/or peripheral facility with Internet or like network capabilities. The marketplace is controlled, at least in terms of implementing the system and method of the present invention, by a controlling entity. Generally, the controlling entity is responsible for overall operation of the on-line site, the commercial transactions conducted thereon and the proper functioning of the auction, raffle or like gaming format. However, while the controlling entity is responsible for the practice of the system and method of the present invention, one preferred embodiment comprises the awarded merchandise being shipped or otherwise transported directly from an original supplier, manufacturer or distributor. The costs, responsibilities, and inconvenience associated with maintaining inventory and/or attending to the transportation of the awarded merchandise are thereby eliminated or significantly reduced.

In typical fashion, the marketplace, as well as the ancillary segments of the gaming format associated therewith, have one or more specific website locations which are easily accessible on-line. In addition, the marketplace also comprises a merchandise collection of at least some of the various products, services and other valuable merchandise categories which may be presented to the interested customers. It is emphasized that the merchandise referred to herein and as displayed in the marketplace are representative only and are not limited to a specific category of products, services, gift certificates, awards, etc. To the contrary, any merchandise having commercial value and being desired by the consuming public may represent “preselected merchandise” which is the subject of the auction or raffle as defined in the various preferred embodiments of the present invention.

Accordingly, implementation of the system and method of the present invention comprises a distribution format structured to award preselected merchandise, through the aforementioned raffle or other gaming format, to one or more customers which purchase one or more bids. Further, the present invention comprises the conducting of one or more auctions, raffles, etc., either independently or concurrently, wherein each raffle or auction relates to specific, preselected merchandise presented for bid. As set forth above, display, review and examination of the various merchandise, prior to or during its selection for bid, may occur by on-line access of any interested customer to the merchandise collection displayed as part of the marketplace.

Once the merchandise is selected for distribution, a bid pool is established comprising a pre-determined number of bids. Each bid is available for purchase and represents an opportunity, typically an equal opportunity, for award of the preselected merchandise. The equal opportunity status of each of the bids in a given bid pool is based on the fact that the winning or selected bid is chosen randomly using computer based random selection or any other appropriate means. Therefore, the random selection of the winning bid is recognized as being more characteristic of a lottery or raffle-type gaming format rather than that of an auction. However, for purposes of descriptive clarity and as detailed above, the terms raffle, lottery and auction may be used interchangeably and are not meant to be interpreted in a limiting sense.

One feature of various embodiments of the present invention is the structuring of the bids which define a given bid pool. As such, the number of bids in a given bid pool are predetermined as is the monetary value or cost of each bid. Moreover, the bid structuring parameters are at least partially based on the original purchase price or established item price of the preselected merchandise presented for bid. As such, the plurality of bids in a given bid pool represent an equal share or percentage of the purchase price, thereby further establishing that each bid represents an equal opportunity for award of the preselected merchandise.

Other features associated with the bid structuring include presenting a pre-determined number of bids in each bid pool, based on the purchase price, wherein the monetary value of each bid is estimated to be acceptable to the customer. By way of example only, preselected merchandise presented for bid may have a purchase price of $600.00. Therefore, the total number of bids defining the bid pool may be 20, wherein the monetary value of each of the 20 bids is $30.00. However, if the monetary value were raised to $100.00 for each bid, the resulting bid pool would comprise only six bids and the customer acceptance of such a high monetary value for each bid may be lessened. In the alternative, if the monetary value were lowered to $1.00 for each bid, the resulting bid pool would comprise 600 bids. While the customer acceptance of an extremely low-value bid may initially be desirable, the time required to sell 600 bids and the potentially large number of customers participating in a given auction or raffle may be impractical. Accordingly, an estimate is used as to the number and value of each bid, such that bid structuring is acceptable to the customer while allowing the auction or raffle to be conducted in a reasonably short length of time.

As indicated above, another consideration in determining the structuring of the individual bids of a common bid pool would be an estimated customer acceptable time for the entire auction or lottery to be conducted. One disadvantage in known on-line auction formats is the length of time it takes to complete the auction. Therefore, a feature of the present invention is the conducting of an auction within a relatively short period of time defined by hours rather than days. Therefore, the estimated time required to sell a pre-determined number of bids is also taken into consideration. Further by way of reference to the above-noted example, it may be easier to sell 20 bids at $30.00 each within a given time period than it would to sell 600 bids at $1.00 each. It is also taken into consideration that the controlling entity of the marketplace desires exposure of the associated website to as many economically appropriate customers as possible.

A related aspect of the present invention is the requirement that all of the bids of a given bid pool must be sold such that the bid pool is completely “exhausted” before the preselected merchandise is awarded. The exhausting of the bid pool also assures the controlling entity of the on-line marketplace that each auction or raffle generates enough money to cover the purchase price of the merchandise offered for bid. As also described in greater detail hereinafter, the exhausting of the bid pool defines a restricted number of customers which have an opportunity for being awarded the preselected merchandise of any one auction associated with the bid pool. However, any one customer may purchase one or more bids in order to increase the chances of winning based on a random selection of the winning bid.

Once a given bid pool has been exhausted, the present invention contemplates the activation of the distribution format, whereby the preselected merchandise associated with a given bid pool is awarded to one of the restricted number of customers holding a bid within that bid pool. However, unique to the distribution format of the present invention is the feature of awarding the preselected merchandise and/or an equivalent thereof to any customer having purchased a number of bids having a collective monetary value to at least equal the purchase price of the preselected merchandise. More specifically, a customer may purchase one or more bids in different bid pools in an attempt to obtain or be awarded a preselected merchandise. If that customer purchases a “winning bid” the preselected merchandise is awarded to the winning bid holder at a “reduced price”. The reduced price is at least partially defined by the total monetary value of the number of bids purchased by that customer prior to be awarded the preselected merchandise.

However, if a customer fails to “win” the preselected merchandise in any of a plurality of successive auctions, that customer has not “lost” his entire investment. Instead, the customer is automatically awarded the preselected merchandise set forth above when he has purchased a number of bids having a collective monetary value at least equal to the purchase price of the preselected merchandise. Accordingly, both the opportunity to obtain merchandise at a potentially reduced price plus the guarantee that the merchandise will be obtained at a cost no greater than the original purchase price is a distinguishing benefit and operative feature of the system and method of the present invention.

As set forth above, the “reduced price” is at least partially defined by the monetary value of the number of bids the customer has purchased in successive auctions until that customer obtains a winning bid. However, the system and method of the present invention further comprises a compensation application. The compensation application is structured to provide a profit or income source to the controlling entity, more specifically described as one or more operators of the marketplace responsible for the implementation of the present invention. Accordingly, the compensation application requires that the customer holding the winning bid pay an auction fee or commission fee to the controlling entity.

Therefore, the “reduced price” of the awarded merchandise is more completely defined as the monetary value of the total number of bids purchased by the winning customer relating to preselected merchandise in addition to the customer's payment of the auction or commission fee. The determination of the auction fee is based on a predetermined percentage of the savings enjoyed by the winning customer. As described in detail hereinafter, a winning customer's “savings” comprises the monetary difference between the original purchase price of the preselected merchandise presented for auction and the monetary value of the total bids purchased by the customer in an attempt to win that preselected merchandise.

Accordingly, the merchandising system and method of the present invention is implemented by a gaming format by means of on-line access to a controlling entity's website. As structured and practiced the gaming format offers a participating customer the potential of obtaining preselected merchandise at a significantly reduced price. In addition, the customer is guaranteed that the monetary investment, relating to the purchasing of bids, will not be lost. More specifically, a customer continuing to participate in successive or additional auctions will be awarded the preselected merchandise at a cost no greater than the original purchase price of the preselected merchandise. Disadvantages and problems associated with conventional merchandising facilities and procedures as well as problems associated with existing or known computer-based auctions or other merchandising techniques are thereby overcome.

These and other objects, features and advantages of the present invention will become more clear when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation in block diagram form of the implementation and operative features of the merchandising system and method of the present invention.

FIG. 2 is a composite view of a merchandise collection including at least some of the available preselected merchandise represented as part of an on-line accessible marketplace and presented in the form of a window or displayed page of a website associated with the system and method of the present invention.

FIG. 3 comprises an on-line accessible window or displayed page of a website representing a gaming format and other operative details of the system and method of the present invention.

FIG. 4 comprises an on-line accessible window or displayed page of a website representing additional features of the gaming format and other operative features of the system and method of the present invention.

FIG. 5 comprises an on-line accessible window or displayed page of a website representing additional features of the gaming format and other operative features of the system and method of the present invention.

FIG. 6 is an on-line accessible window or displayed page disclosing in part a preferred embodiment relating to a compensation application and other operative features of the system and method of the present invention.

FIG. 7 is an on-line accessible window or displayed page of a preferred embodiment relating to a “Buy-It-Now” option of the system and method of the present invention.

FIGS. 8A, 8B and 8C are each on-line accessible windows or displayed pages of another preferred embodiment relating to a “Funds Transfer” option of the system and method of the present invention.

FIGS. 9A, 9B and 9C are each on-line, accessible windows or displayed pages of another preferred embodiment relating to a “Product Upgrade” option of the system and method of the present invention.

FIG. 10 is a schematic representation in block diagram form of another preferred embodiment relating to an electronic gift card option of the present invention.

Like reference numerals refer to like parts throughout the several views of the drawings.

### DETAILED DESCRIPTION OF THE PREFERRED EMBODIMENT

As represented in the accompanying Figures, the present invention is directed to a system and method of on-line merchandising of a variety of different products, services, gift cards and any other type of merchandise having commercial value and appeal to the general consuming public. Practice and implementation of the present invention is conducted on-line using the Internet or other communication network by accessing a “marketplace” website. Practice of the present invention more specifically entails the implementation of a gaming format such as a raffle, lottery and/or auction-type system. Moreover, the specific terminology used to describe the gaming format of the present invention is not meant to be interpreted in a limiting sense. Accordingly, the terms raffle, lottery, and/or auction may be used interchangeably to describe the functional and operational features of the present invention, as set forth in detail hereinafter.

Further, the operative components and functional characteristics of the present invention, which are distinguishable from known or conventional on-line or computer-based merchandising techniques, provide a plurality of customers the opportunity to obtain preselected merchandise at a potentially reduced price. In addition, the system and method of the present invention provides the additional, highly attractive feature of guaranteeing an award of the preselected merchandise to a continuously participating customer at a cost substantially equal to the original or pre-determined purchase price (listed item price) of the preselected merchandise.

Accordingly, a plurality of customers establish on-line access to the marketplace available at one or more web sites maintained and operated by a controlling entity. The marketplace includes a plurality of easily accessible windows or displayed pages each demonstrating in a clear and informative manner the various components of the present invention, as well as procedures and operative features relating to its practice. With reference to FIG. 2, the marketplace comprises a merchandise collection generally indicated as 10 and including a composite display of the various products, services, gift certificates and/or other valuable merchandise available to be awarded or obtained through the a raffle, lottery, auction, or like gaming format. The merchandise displayed in FIG. 2 is representative only of the various types of merchandise which are available to a large number of customers participating in the system and method of the present invention. The merchandise collection, as part of the marketplace of a preferred embodiment of the present invention, may also include a plurality of merchandise categories generally indicated as 12. By way of example only, the merchandise categories 12 may include computers, photo and video equipment, electronics, video games, movies, travel, toys as well as a variety of other such categories. The availability of the category display 12 in combination with the composite representation of the merchandise of FIG. 2 facilitates the access by an on-line customer to specific merchandise associated with the respective categories which may be of primary interest to the customer.

As emphasized above, the raffle, auction or like gaming format which defines certain operative features of the present invention includes the establishment of a “bid pool” 14. Each bid pool 14 includes a pre-determined number of bids, each of which are available for on-line purchase. As demonstrated in FIG. 3, a currently operating auction 13 comprises an active bid pool 14 as well as a schematic representation of a previous bid pool 14′, wherein the auction 13′ associated therewith has already been completed. Each of the plurality of bids in a given bid pool 14 and 14′ represents an equal opportunity to be awarded preselected merchandise 16. As further demonstrated in FIG. 3, the preselected merchandise 16 represents a product, service, etc., which is the subject of the current auction 13 as well as the previous auction 13′. As indicated above, preselected merchandise associated with any given auction 13 and its associated bid pool 14 may of course vary and may be determined by customer demand and/or be under the supervision of the controlling entity of the marketplace.

Additional features demonstrated in the displayed window/page of FIG. 3 include a display of the purchase or item price 17 as well as informative data 18 relating to the preselected merchandise 16, as well as informative parameters of the current auction 13 and results of the previous auction 13′. Further with regard to the bid pools 14, 14′, each comprises a pre-determined number of bids having an established monetary value. The monetary value of each bid in a given bid pool is at least partially determined by the purchase price 17 of the preselected merchandise 16, displayed as the “item price” in FIG. 3, and a variety of other factors. As such, each of the bids represents a “share” or percentage of the purchase price 17 of the preselected merchandise 16.

The structuring of the bids in terms of the number of the bids available for purchase in any given bid pool 14 is additionally determined by an estimated value. As used herein, the “estimated value” is a determination of a bid value which is believed to be acceptable to a customer in terms of attracting an optimum or acceptable number of customers to participate in each of the raffles or auctions. By way of example only and again with primary reference to FIG. 3, it may be a realistic estimate to establish 20 bids in a given bid pool 14 based on the purchase price 17 of the preselected merchandise 16 being $600.00. As such the value or customer cost of each bid, being equal, would be $30.00. The $30.00 value of each bid would an estimate of a purchase price that would be acceptable to a large number of customers.

In addition, the bid structuring of the present invention comprises the establishment of a predetermined number of bids which would best facilitate a bid pool 14 being exhausted or sold out within a relatively short and/or optimum period of time. Therefore, the determination that 20 bids define the number of bids in a given bid pool would represent an estimate, believed to be customer acceptable, of the number of bids which could be sold in an acceptable time period. This would overcome the recognized disadvantages of known on-line auction systems, which typically take several days to complete.

Moreover, an additional operative feature of the present invention is the necessity of exhausting the bid pool, by selling all of the plurality of bids defining a specific bid pool 14, before the auction 13 can take place. This will assure that each of the auctions 13, 13′, etc., generate sufficient monetary funds to at least cover the purchase or unit price 17 of the preselected merchandise 16. At the same time, each bid represents an equal opportunity for the bid holding customers to be awarded the preselected merchandise 16.

With further reference to FIG. 3, additional information available to on-line customers includes the time and/or time remaining 21 of the current auction 13; the provision of a window or screen-shot button 22 for the purchase of one or more of the plurality of bids; the updated status 24 of the current auction 13 in terms of total, pre-determined number of bids in the bid pool 14; the bids remaining for purchase or “available bids”; and the cost of each bid. Similarly, information relating to the previous auction 13′ may include the display of at least a partial identity of the winning customer 26; the date and time of auction termination 28; and the “reduced price” at which the winning customer 26 obtained the preselected merchandise 16, which was the subject of the auction or raffle 13′. Also, additional information relating to the previous auction 13′ may be provided and include that there were 20 total bids contained in the bid pool 14′; the winning customer 26 purchased three bids and this three bid purchase resulted in a $90.00 investment by the wining customer 26, based on the fact that each bid was purchased for an individual monetary value of $30.00.

Other components and operative features of the various preferred embodiments of the present invention are demonstrated throughout the accompanying Figures. More specifically, an “Auction Info” screen segment, generally indicated as 34, is continuously or selectively available and includes information relating to current, past and future auctions and possibly a variety of other topics. More specifically, such informative data comprises, but is not limited to, various icon-type indicators, which may be displayed as a composite and generally indicated as 35. Such icon indicators provide additional auction information in terms of indicating the bids purchased by a given customer; bids purchased by an auto-bid format 36 (to be described in greater detail hereinafter); bids placed in one or more previous auctions; an indicator for the one or more winning bids in a plurality of auctions and further indicators representing the non-winning or losing bids. Also, the Auction Info segment 34 may provide an active diagram 38 of information of a given customer, as well as the participation by competing customers as a percentage of the bids still available for purchase; the percentage of bids purchased by a single customer; and the percentage of bids purchased by other customers; all relating to a common bid pool 14 and/or 14′.

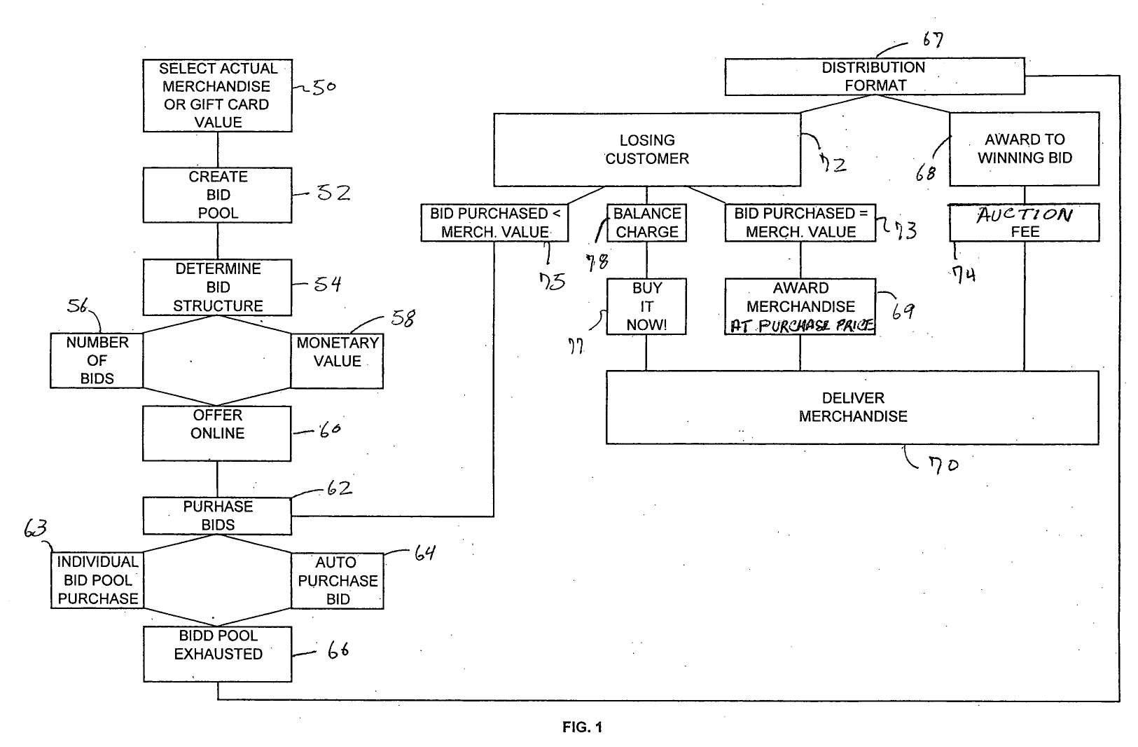

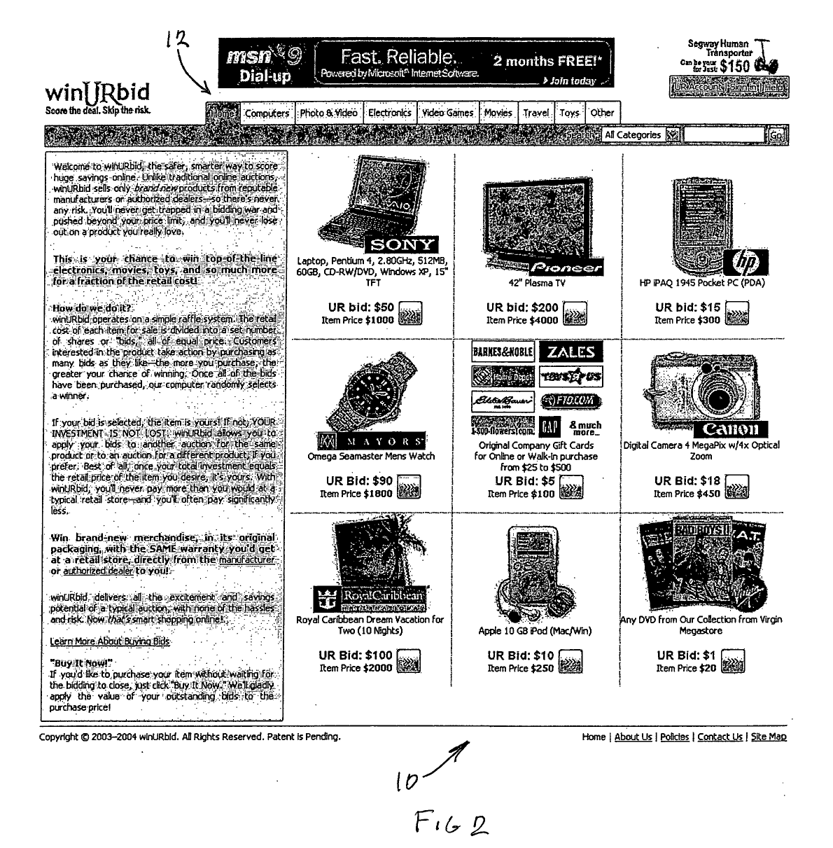

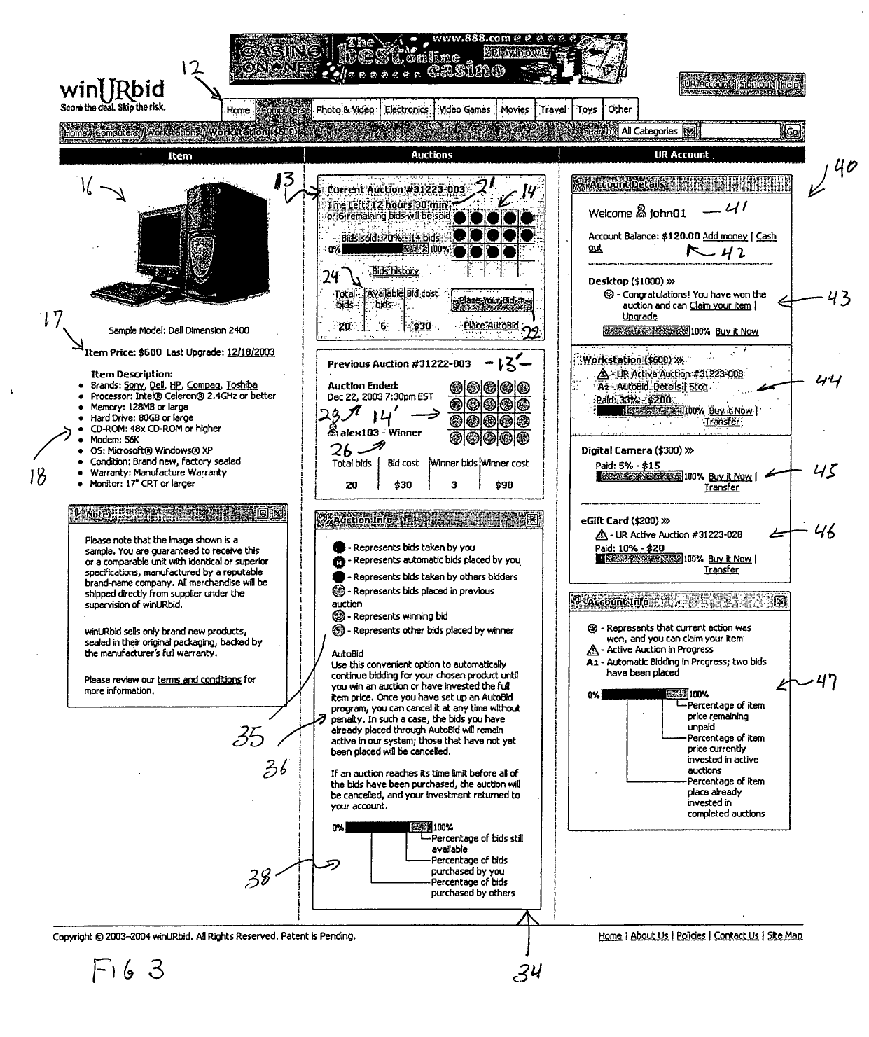

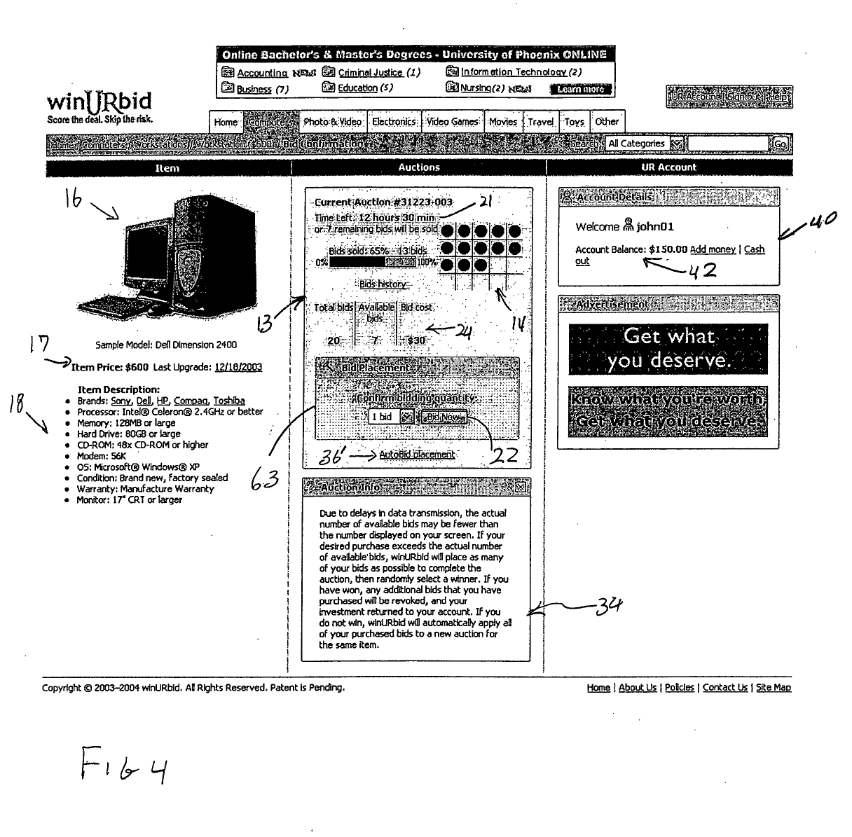

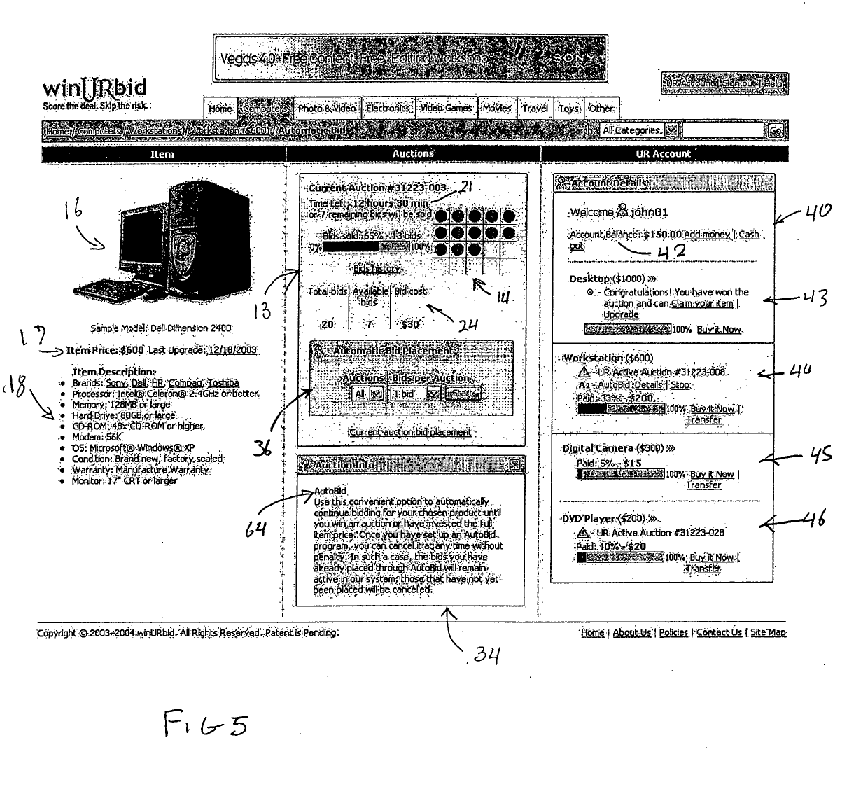

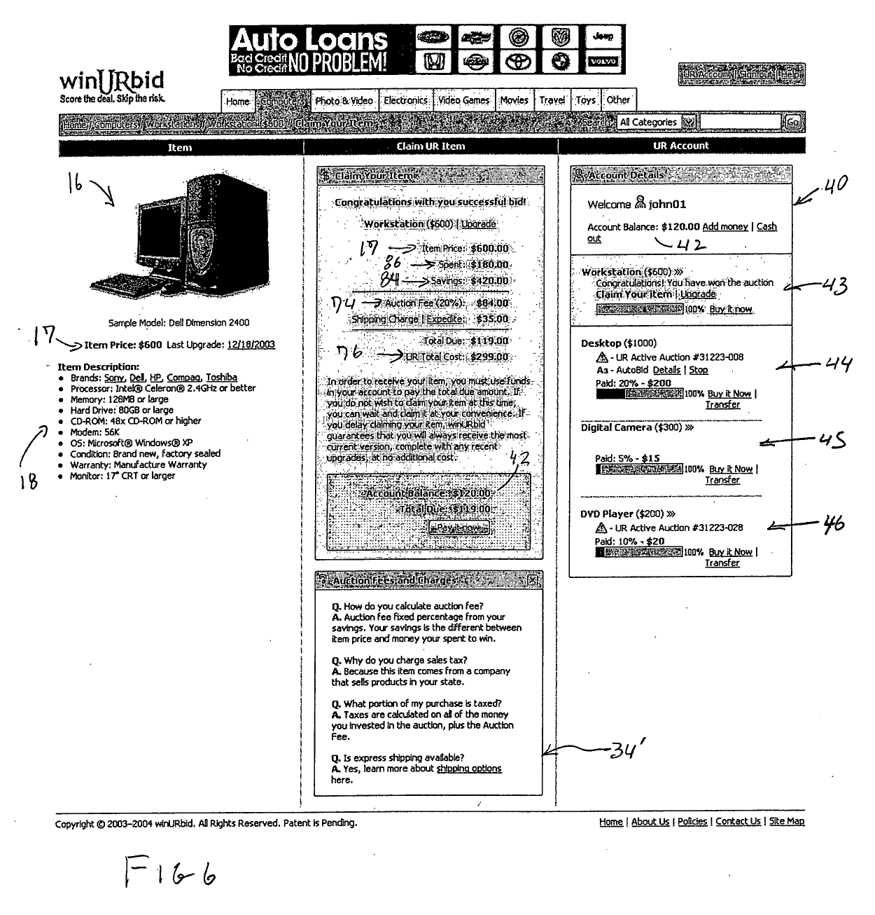

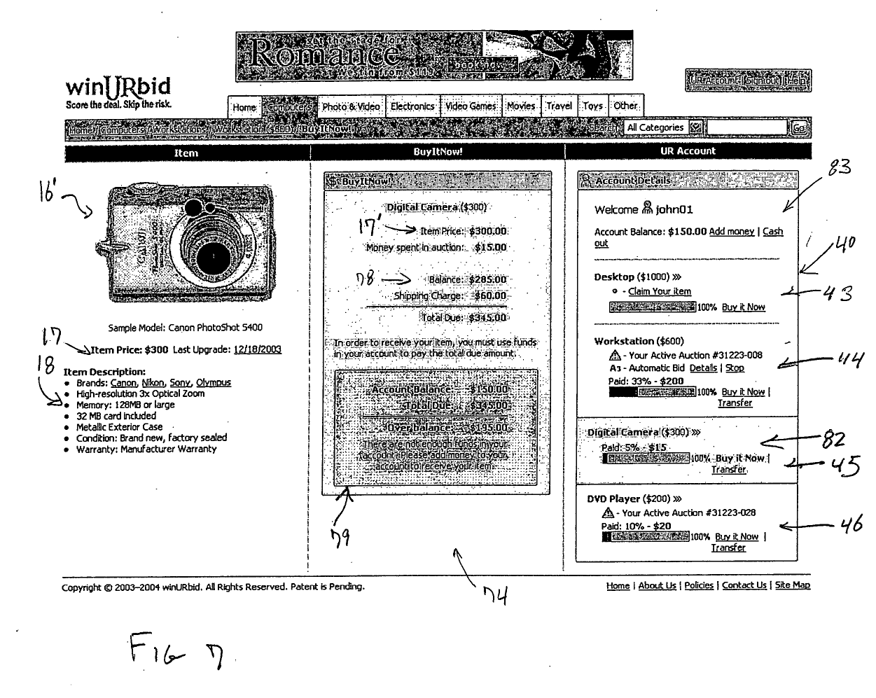

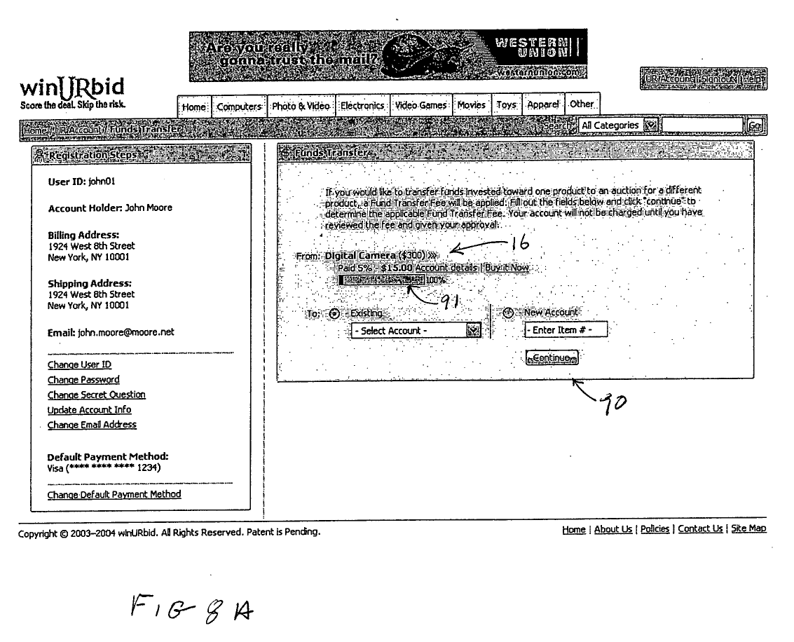

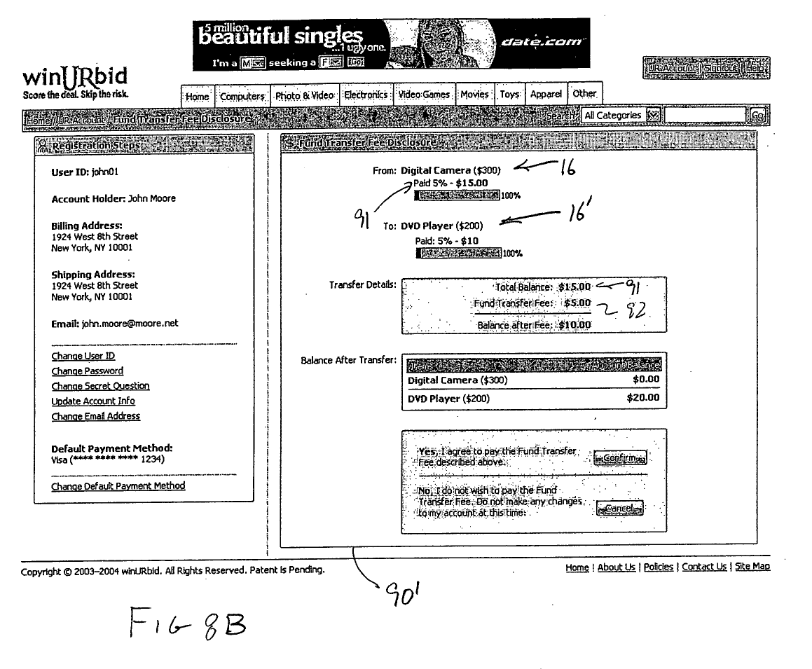

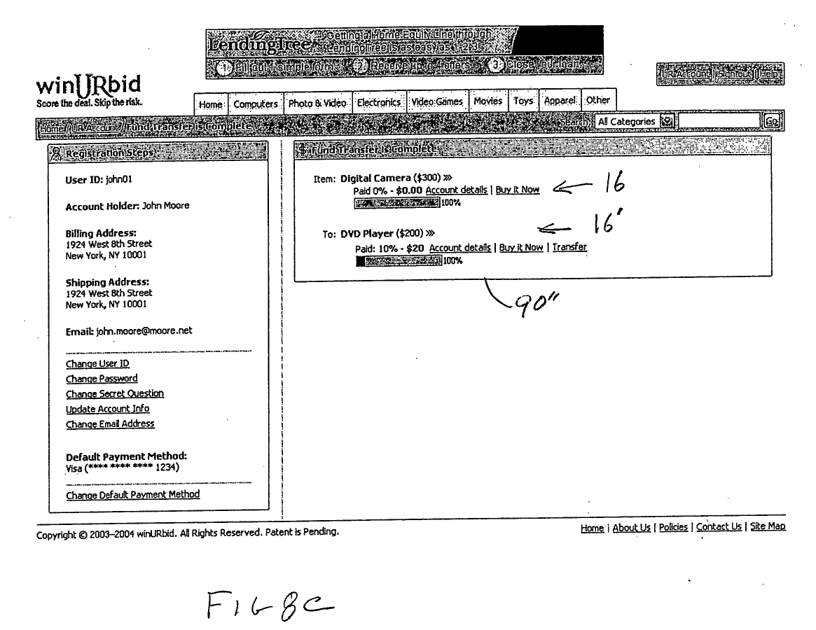

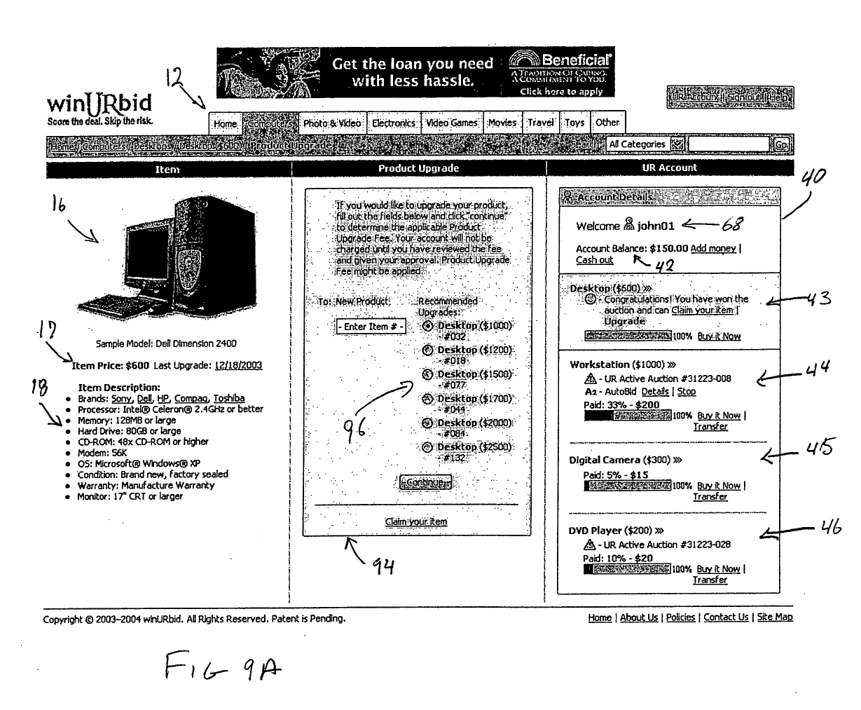

In order to keep each of the on-line customers fully informed as to the status of their individual financial account(s), as well as provide an on-going reference to their participation or position in current, past and future auctions, an “Account Details” screen segment 40 is provided on appropriate displayed widow/pages. With specific reference to FIG. 3, the Account Details segment 40 may include the identity of the individual customer 41, an account balance 42, plus the selective ability to add money to one's account or to cash out or have the funds in the account balance 42 returned. In addition, information relating to the successful winning of an auction 43 may be provided as well as the specific details relating to the won auction. Further, the status of the individual customer 41 relating to one or more future auctions as at 44, 45, 46, etc., is also informatively displayed. Moreover, each of the future auction window segments 44-46 may provide the customer 41 with a plurality of selections relating to the continued participation in a given auction; the ability to choose a “Buy-It-Now” option 77, as discussed with reference to FIGS. 1 and 7; the ability to transfer the value of the purchased bids to another preselected merchandise, as discussed in FIGS. 8A through 8C, and a current value of the one or more bids purchased by the customer 41 in each of one or more future auctions 44-46. As an added component of the Account Detail segment 40, additional related information termed “Account Info”, generally indicated as 47, may also be provided. Such an “Account Info” segment 47 may comprise an active graph similar to that demonstrated in the window segment 34 relating to “Auction Info” but more directly associated with the account details of the specific customer 41 as described with reference to the Account Details segment 40, set forth above.

The operative features and components of the merchandising system and method of the present invention will be further clarified hereinafter with primary reference to FIG. 1 as well as the various features of the preferred embodiments as represented in FIGS. 3 through 9. More specifically, operation of the system and method of the present invention, including the responsible implementation of the various embodiments by a controlling entity (not shown for purposes of clarity), may best begin with the selection of merchandise as at 50. The selected merchandise is represented in the various Figures as the preselected merchandise 16, 16′, 16″, etc. and may vary when conducting different auctions each including a different bid pool 14. As such, the bid pool 14 is created, as at 52, by determining the bid structuring 54. The bid structuring 54, under the responsibility of the controlling entity, relates to the determination of the number of bids in the bid pool 14, as at 56, as well as the monetary value 58 of each of the plurality of bids of a given bid pool 14.

As previously indicated, the number of bids and the monetary value thereof are based on plurality of factors including an established purchase price or item price 17 of the preselected merchandise 16. The number of bids 56, in any given bid pool, will be based on a customer-acceptable estimated value 58 as well as an estimated time period for conducting the raffle or auction before awarding the preselected merchandise 16. Further, the plurality of bids each represent a “share” of the purchase price of the preselected merchandise 16, and therefore each of the plurality of bids of a given bid pool 14 will have the same monetary value 58.

Once the bid pool 14 has been created, through proper structuring of the plurality of bids 54, they are offered for on-line purchase, as at 60. With additional reference to FIGS. 4 and 5, the purchase 62 of the bids can be accomplished by any customer visiting the website of the marketplace and preferably, but not necessarily, establishing a financial account. As set forth above, the status of a customer's individual financial account will be currently updated, depending upon the customer's activity and indicated in the Account Details segment 40 which is displayed on appropriate windows represented throughout the various Figures. The establishing of a financial account facilitates the purchase of one or more bids either individually or “manually”, as at 63 (see FIG. 4), or through an “Auto-Bid Format” 64 (see FIG. 5). More specifically, an individual bid may be placed by activating the “Bid Now” screen displayed button 22, wherein current information is instantaneously displayed to the customer at least in terms of bid quantity.

Alternatively, at least one preferred embodiment of the present invention comprises the auto-bid format 64 schematically represented in FIG. 1 and informatively described in the Auction Info segment 34 of FIG. 5. As such, the auto-bid format 64 provides for a customer establishing the above noted financial account and authorizing the automatic, continued purchase of at least one bid in a plurality and/or successive auctions for the same or equivalent preselected merchandise 16. As indicated, the auto bid format 64 can be cancelled at any time, but will normally continue until customer purchases a winning bid. However, it is recognized that the customer may never purchase a wining bid. If this occurs, the customer will still not lose his investment, as described in greater detail hereinafter. The purchase of bids 62 by any of a plurality of customers, through on-line access, can be accomplished by a customer individually, as at 63, or automatically, as at 64, once the customer has determined in which, if any, of the auctions he/she wishes to participate. Moreover, a customer may purchase one or more bids from a given bid pool 14 and if not awarded the preselected merchandise 16 may choose not to participate in the next auction or any other successive auction.

Regardless of the procedure used to purchase 62 the one or more bids in a given bid pool 14, the auction will begin only when the bid pool has been exhausted, as at 66. As indicated above, the exhaustion of the bid pool is defined as the selling of all of the predetermined number of bids in any given bid pool 14. This assures that the total value of any exhausted bid pool is at least equal to the purchase price 17 of the preselected merchandise 16. The controlling entity of the marketplace will thereby be provided sufficient income dollars to cover the purchase price 17 of the preselected merchandise 16. Once the bid pool 14 has been exhausted, as at 66, the award of the preselected merchandise 16 will commence through activation of the distribution format 67.

Therefore, one distinguishing feature of the system and method of the present invention is the structuring of the distribution format 67 in a manner which provides for the awarding of the preselected merchandise 16 at a “reduced price” to a customer holding a winning bid, as at 68. In addition, the preselected merchandise 16 is also guaranteed to be awarded to any “losing” customer 69 which has already purchased a sufficient number of bids, wherein the total monetary value of all the bids purchased is at least equal to the purchase price or unit price 17, as at 53. Therefore, the structuring of the distribution format 67 provides an opportunity to obtain merchandise at a significantly reduced price, by obtaining the winning bid through the purchase of only a small number of bids, as at 68, and the guarantee that the merchandise will be awarded at a cost no greater than the purchase price 17, as at 69.

As further indicated in FIG. 1, the situation will frequently occur where many or even most of the losing customers 72 participating in a given bid pool 14, will have purchased one or more bids which have a total monetary value less than the purchase price 17, as at 75. In such situations, each of the losing customers 72 having purchased an insufficient number of bids 75, may or may not continue participation in successive bid pools 14. However, in order to guarantee a customer the award of the merchandise 16, at a price no greater than its purchase price 17, at least one preferred embodiment of the present invention necessitates continued participation of that customer in successive bid pools.

Such continued participation comprises the purchase of bids from bid pools 14 of other, successive auctions 13 for the same preselected merchandise 16, until the monetary value of the total number of bids purchased by a customer is at least and/or substantially equal to the purchase price 17 of that preselected merchandise 16. Once an equivalent monetary value has been reached, the continuously losing customer is awarded the merchandise 16 at the full purchase price, which is substantially equal to the total monetary value of all the bids that customer has purchased at successive raffles or auctions. As with the purchase of bids from any bid pool 14, the losing customer may participate in the auto-purchase application 64 or may otherwise purchase bids individually as at 63.

With further reference to FIG. 1, a losing customer 72 has yet another alternative comprising a “Buy-It-Now” option 77, which is represented in greater detail in FIG. 7. More specifically, situations may arise where a losing customer 72 is desirous of obtaining the preselected merchandise 16, 16′, etc., immediately without participating in successive auctions and/or bid pools. In this situation, the losing customer 72 relinquishes the possibility of purchasing a winning bid 68. But, for any of a variety of reasons, the customer may wish to take possession of the preselected merchandise 16, 16′ as soon as possible.

Accordingly, the losing customer 72, in accord with the “Buy-It-Now” option 77, will have the balance, represented as 78 in both FIGS. 1 and 7, charged to his/her account, which is maintained with the controlling entity. The balance 78 in the example presented in FIG. 7 equals $285 which is the difference between the money spent on bids in one or more auctions ($15) and the purchase or item price 17′ of the preselected merchandise 16′ ($300). The charging of the balance 78 for the preselected merchandise 16′ is, as set forth above, deducted or debited from the account maintained by the specific losing customer 72 as represented in FIG. 7 as 79. The various Account Details 40 are also concurrently displayed to inform any given customer his/her immediate financial condition in any of a plurality of auctions, such as but not limited to the specific auction as at 82 relating to the preselected merchandise 16′. In providing a customer with an accurate account of his/her activities and financial situation including, but not limited to, his/her account balance 83, all of the activities concerning past, current and future auctions are also represented in FIG. 7.

As also schematically represented in FIGS. 1 and 6, other features of preferred embodiments of the present invention include the provision of a compensation application which may represent a primary or at least significant profit source for the controlling entity of the marketplace website. The compensation application is structured to include the payment of an auction fee or commission fee 74 to the controlling entity by each customer holding the winning bid 68. As such, the aforementioned “reduced fee”, generally indicated as 76, at which any customer has the opportunity to obtain the preselected merchandise 16, 16′, etc, is defined as the monetary value 86 of the total number of bids which the customer needed to purchase to obtain a winning bid. Also, the reduced price 76 includes the additional factor of the winning customer 68 paying the commission or auction fee 74.

Again, with primary reference to FIG. 6, the auction fee 74 comprises a predetermined percentage of the “savings” 84 enjoyed by the winning customer 68. In turn, the savings 84 is defined as the difference in the purchase price 17 of the preselected merchandise 16 and the monetary value 86 of the total number of bids purchased by the winning customer until the winning bid was obtained and the preselected merchandise 16 was awarded. As such, it should be apparent that the auction fee 74 is inversely proportional to the monetary value 86 of the total number of bids purchased for the preselected merchandise by the winning customer. In other words, the more the customer spends on purchasing bids 86, the less that customer will realize in savings 84. Therefore, the smaller the savings 84 the smaller the commission fee 74 paid by the winning customer 68. Also, it should be apparent that when a customer is awarded the preselected merchandise at full price, as at 69, due to the purchase of a sufficient number of non-winning bids, that customer's “savings” is zero since the merchandise will be obtained by the losing customer at a cost substantially equal to the original purchase price or item price 17.

Yet additional features which may be attractive to both the controlling entity of the marketplace and/or the plurality of customers, include the existence and transfer of original warranties on the products as supplied by the original supplier or manufacturer. Further, in a preferred embodiment the preselected merchandise 16, 16′, etc, whether awarded at the full purchase price, as at 68; obtained by the “Buy It Now” option 77; or awarded to the winning bid holder, as at 69, is preferably shipped or otherwise delivered, as at 70, directly from the manufacturer or supplier. Therefore, if the customer has an issue relating to delivery and/or condition of the product, it is dealt with directly by the supplier or manufacturer. Also, no costs or inconvenience associated with maintaining an inventory of merchandise need be suffered by the controlling entity.

Other features demonstrated in at least some of the preferred embodiments of the present invention are intended to assure customer satisfaction. More specifically, situations may arise where the preselected merchandise 16, 16′, etc., intended to be presented for bid, may not be available. In such circumstances, the merchandise will be upgraded and changed to substantially equivalent merchandise. If such an event occurs, the bids purchased from a given bid pool will be automatically applied to the upgraded or other equivalent merchandise.

Yet another preferred embodiment of the present invention is schematically represented in FIGS. 8A-8C and comprises an option which allows any customer to transfer the value of his purchased bids on a specific preselected merchandise 16 to an equivalent value of bids for a different preselected merchandise 16′. This “Funds Transfer” option is generally indicated and described by sequential screen segments 90, 90′ and 90″ respectively presented in FIGS. 8A-8C. With reference to the example presented in these Figures, a customer has purchased a number of bids attempting to obtain preselected merchandise 16, such as a digital camera. Thereafter the same customer wishes to obtain other preselected merchandise, such as a DVD player 16′. When taking advantage of this option of the present invention, the value of the previously purchased bids, as at 91, can be transferred to or credited against the purchase of the other merchandise 16′ such as the DVD player. In such situations, a funds′ transfer fee, as at 92, may be charged to the customer. As represented, the result would be a zero balance applied to the digital camera 16 and an increased monetary value transferred or applied towards the DVD player 16′ as demonstrated in FIG. 8C.

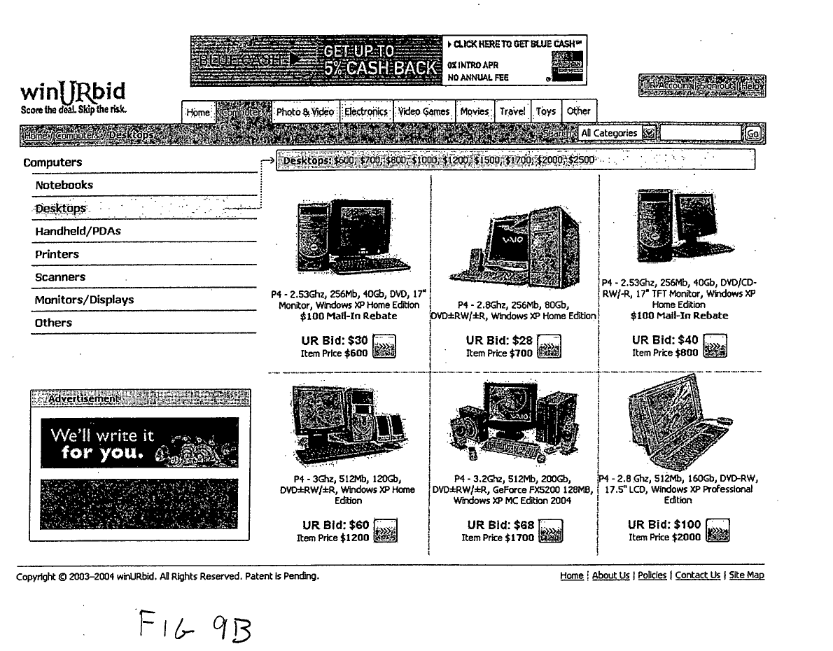

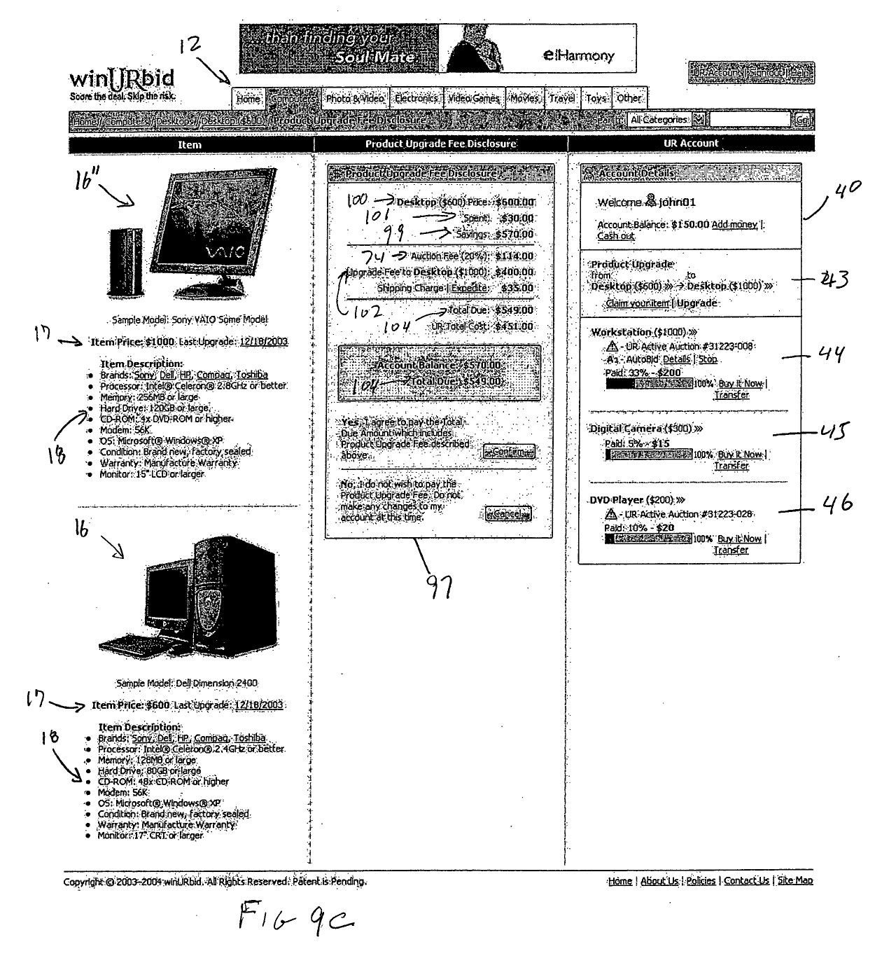

The versatility and customer appeal of the on-line merchandising system and method of the present invention is further demonstrated in yet another preferred embodiment, represented and described in FIGS. 9A-9C. More specifically, each customer specifically including, but not limited to, the winning customer 68, has the option of a “product upgrade” as generally represented in the window segment 94. As indicated above, the marketplace and associated auction website presents numerous categories of merchandise for auction. Within each category, such as an electronics category 12′, a plurality of products may be represented. Those products may include a variety of different desktop computers ranging in style, performance capabilities, etc., resulting in different prices. The window segment 94 therefore demonstrates a plurality of the different styles of desktop computer products and is generally represented as 96. Accordingly, a winning customer 68 of a preselected merchandise 16, comprising one type of desktop computer (# 032), will be presented with the product upgrade option 94. As part of this product upgrade option 94, the plurality of different styles, types, etc., of computers 96 may be accessed and visually displayed as represented in FIG. 9B. Again, assuming that the customer 68 was a winning bid holder and decided to choose an upgrade to a different desktop computer, as at 16″ in FIG. 9C, he/she would be allowed to do so and be subsequently presented with the financial data or criteria for obtaining the upgraded merchandise 16″. At the same time, the winning customer 68 would be able to enjoy the benefit of holding a winning bid which enabled the customer 68 to obtain or be awarded the original merchandise 16 at a greatly reduced price. As set forth above, the reduced price would be at least partially determined by the savings 99, defined by the difference between the purchase price 100 and the total monetary value of the bids purchased in an attempt to win the original preselected merchandise 16, as at 101. As also set forth above, an auction fee or commission fee 74 would be added to the reduced price, based on the amount of savings 99. The upgrade fee 102 would be the difference between the purchase price of the original merchandise 16 and the purchase price of the upgraded merchandise 16″. Additional administrative charges such as shipping charges may be added to determine the total amount due 104 from the winning customer 68 which need be paid to obtain the upgraded merchandise 16″. It should be further noted that any customer, whether being designated as a winning customer or losing customer, can participate in the product upgrade option 94, 97 as described. In the case of a losing customer, the total monetary value of all the bids purchased by the losing customer would be applied against the purchase or unit price 100 of the upgraded merchandise 16″ even though the losing customer purchased bids on the original preselected merchandise 16.

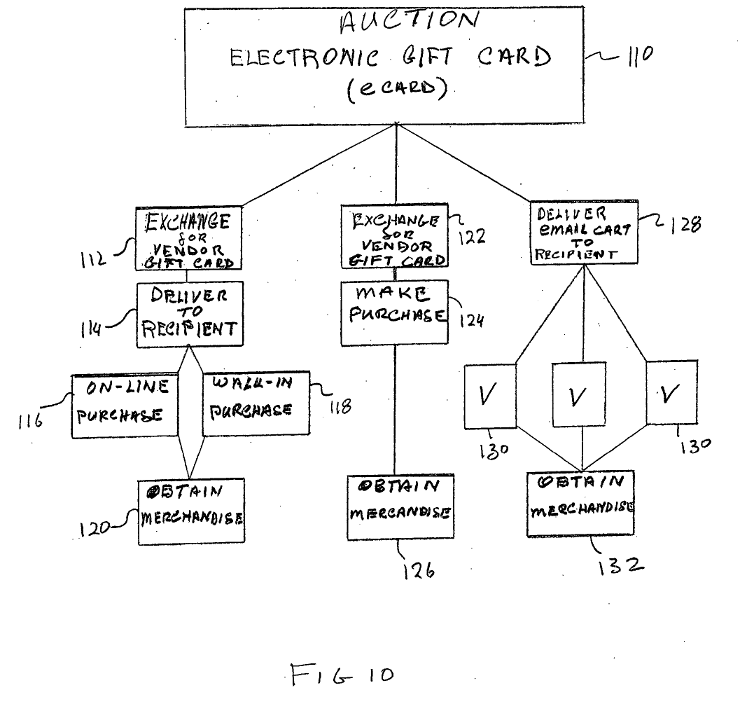

As set forth above, one of the many features of the present invention comprises the ability to auction or raffle a plurality of different categories and types of merchandise, wherein the merchandise is not limited to a product or service. Accordingly, with primary reference to FIG. 10, one preferred embodiment of the present invention comprises the preselected merchandise being defined by a gift card or certificate more appropriately termed an “Electronic Gift Card” indicated as 110. For purposes of clarity, the term “Electronic Gift Card” is not meant to be interpreted in a limiting sense. As such, a variety of different terms, logos, trade names, etc., may be used herein and in a practical commercial application to identify the Electronic Gift Card or its equivalent. Such additional terms may include “eMoney”, “eCard” and/or a plurality of other terms generally representative of the electronic or computerized transactional nature of this merchandise. In addition, the Electronic Gift Card is structured and functionally designed to be utilized in a plurality of different types of commercial transactions.

Again with reference to FIG. 10, one option for commercially transacting the Electronic Gift Card comprises the winning customer or bid holder exchanging the Electronic Gift Card for a gift certificate or gift card of one of a plurality of specific vendors 112. Thereafter, the specific vendor gift card 112 is delivered to an intended recipient, as at 114, for which the winning customer intended a gift. The recipient thereafter has the option of choosing a variety of different merchandise of the specific vendor. Moreover, the merchandise can be selected and/or purchased on line as at 116 or by visiting one or more of the vendor's physical locations in order to accomplish a walk-in purchase, as at 118. Regardless of whether the purchase of the merchandise is an on-line transaction 116 or a walk-in transaction 118, the merchandise is then obtained by the recipient as at 120. Obtaining the merchandise by the recipient may comprise delivery by any conventional or other appropriate means, especially when the merchandise is purchased on-line 116. Alternatively, when purchasing merchandise by a walk-in transaction 118, the recipient may take possession of the merchandise in the conventional fashion at the vendor's physical establishment or have it delivered by conventional or appropriate means.

Yet another option associated with the commercial transaction of the electronic gift card comprises the winning customer or bid holder exchanging the electronic gift card for a gift certificate or gift card of a specific vendor, as at 122. The customer, then being in possession of the specific vendor's gift certificate, will select and purchase merchandise as at 124 from the vendor. The selection and purchase of the merchandise can preferably be conducted on line in order to eliminate the inconvenience of visiting a physical outlet or location of the specific vendor. However, it is emphasized that the electronic gift card is structured and operative to allow the winning customer to visit any of one or more of the vendor's physical facilities or outlets. Obtaining of the merchandise, as at 126, represents such merchandise being delivered to the recipient either directly by the winning customer or by other conventional or appropriate means.

The commercial versatility of the electronic gift card is further demonstrated in yet another option, wherein the electronic gift card itself is delivered to the recipient. Such delivery can be arranged by the winning customer and can be conducted on line. Alternatively, the winning customer can obtain some type of hard copy evidence representing of the electronic gift card and send or otherwise deliver the hard copy representation to the recipient as at 128.

In practicing this particular option, the electronic gift card or the hard-copy representation will not necessarily be limited to a specific vendor as in the previous options 112 and 122. To the contrary, the electronic gift card can be a universal or “No Name” card or certificate. As such, the recipient, once in the possession of the electronic gift card and/or its hard-copy representation, can visit any of a plurality of vendors 130 which have been integrated into the merchandising system and method of the present invention to the extent of the vendor accepting the electronic gift card and exchanging it for desired merchandise. As with the previously described options relating to the commercial transaction of the electronic gift card 110, a prearrangement will be made with a plurality of vendors wherein the number and popularity of the vendors will be such as to provide the recipient and/or the winning customer with a wide choice of merchandise from which to select and purchase. As with the previous options, the merchandise is obtained by the recipient by direct physical possession and/or conventional or appropriate delivery means. Further, once the recipient receives the “No Name” electronic gift card, an appropriate commercial transaction with any of the plurality of vendors 130 can be conducted either on line or by means of a walk-in transaction, as described above.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

1. A system of on-line merchandising at a potentially reduced price, the system comprising:
A. a marketplace accessible on line and comprising a controlling entity and a merchandise collection,
B. a distribution format structured to award preselected merchandise to at least one of a restricted number of customers,
C. a bid pool comprising a predetermined number of bids, each bid available for purchase and representative of an opportunity for award of the preselected merchandise,
D. each bid comprising a monetary value equal to a predetermined share of the purchase price of the preselected merchandise, and
E. said distribution format further structured to award the preselected merchandise at a reduced price to a selected one of the restricted number of customers and to a customer having purchased a sufficient number of bids to at least substantially equal the purchase price of the preselected merchandise.

2. A system as recited in claim 1 wherein said distribution format comprises a raffle application, said raffle application participated in by the restricted number of customers.

3. A system as recited in claim 1 wherein the selected one of the restricted number of customers is determined by a random selection.

4. A system as recited in claim 1 wherein said merchandise collection comprises a displayed array of merchandise accessible on line.

5. A system as recited in claim 1 wherein said bid pool is structured for on-line access to and purchase of said predetermined number of bids.

6. A system as recited in claim 5 wherein instigation of the distribution format is responsive to exhaustion of said bid pool through purchase of all said predetermined number of bids.

7. A system as recited in claim 6 wherein each of said restricted number of customers is defined by a purchase of at least one of said plurality of bids.

8. A system as recited in claim 7 wherein any one of said restricted number of customers may purchase one or more bids until said bid pool is exhausted.

9. A system as recited in claim 5 wherein on-line access to said bid pool comprises a visual display of purchased and un-purchased bids.

10. A system as recited in claim 1 wherein a collective monetary amount of all the predetermined number of bids in the bid pool is equal to the purchase price of the preselected merchandise.

11. A system as recited in claim 10 wherein the predetermined number of bids in the bid pool is at least partially determined by an estimated bid price.

12. A system as recited in claim 11 wherein the predetermined number of bids in the bid pool is at least partially determined by an estimated time period required to exhaust the bid pool through purchase.

13. A system as recited in claim 10 wherein the predetermined number of bids in the bid pool is at least partially determined by an estimated time period required to exhaust the bid pool through purchase.

14. A system as recited in claim 1 wherein said bid pool further includes an automatic bid format.

15. A system as recited in claim 14 wherein said automatic bid format comprises a repetitive automatic purchase of at least one bid from each of a plurality of different bid pools.

16. A system as recited in claim 15 wherein each of said plurality of different bid pools is associated with the award of substantially equivalent preselected merchandise.

17. A system as recited in claim 1 further including a compensation application comprising compensation paid to the controlling entity by customers awarded the preselected merchandise.

18. A system as recited in claim 17 wherein said compensation application comprises a commission fee at least partially defined by a predetermined percentage of a customer's savings on the awarded preselected merchandise.

19. A system as recited in claim 18 wherein the customer's savings is at least partially determined by a monetary difference between the purchase price of the awarded merchandise and the monetary value of the total number of bids purchased by the selected one customer on the awarded merchandise.

20. A system as recited in claim 19 wherein said reduced price is at least partially defined as the monetary value of the total number of bids purchased by the selected one customer for award of the preselected merchandise in addition to the commission fee.

21. A system as recited in claim 20 wherein the commission fee is inversely proportional to the monetary value of the total number of bids purchased for the preselected merchandise by the selected one customer.

22. A method of on-line merchandising at a potentially reduced price, said method comprising:
displaying a merchandise collection by on-line access,
establishing at least one bid pool comprising a predetermined number of bids each being representative of an opportunity to be awarded preselected merchandise,
presenting the predetermined number of bids for on-line purchase,
structuring each of the bids to represent a predetermined share of the purchase price of the preselected merchandise,
awarding the preselected merchandise at a reduced price to at least one customer of a restricted number of customers having purchased at least one bid, and
awarding the preselected merchandise to any customer having purchased a sufficient number of bids to at least substantially equal the purchase price of the preselected merchandise.

23. A method as recited in claim 22 comprising selecting the one customer of the restricted number of customers by random selection.

24. A method as recited in claim 22 comprising structuring each of the predetermined number of bids to represent an equal opportunity to be awarded the preselected merchandise.

25. A method as recited in claim 24 comprising allowing each of the plurality of customers to purchase one or more bids until the bid pool is exhausted.

26. A method as recited in claim 25 comprising requiring the pre-determined number of customers to purchase at least one bid.

27. A method as recited in claim 25 comprising requiring the restricted number of customers to be at least two in number.

28. A method as recited in claim 22 comprising activating at least a portion of the distribution format subsequent to exhaustion of the bid pool.

29. A method as recited in claim 22 comprising structuring the value of each of the plurality of bids of a common bid pool to be equal.

30. A method as recited in claim 29 comprising structuring the collective value of the plurality of bids of a common bid pool to be equal to the purchase price of the preselected merchandise.

31. A method as recited in claim 22 comprising determining the number of the plurality of bids in a common bid pool by an estimated bid price.

32. A method as recited in claim 31 comprising further determining the number of the plurality of bids in a common bid pool by an estimated time period needed to exhaust the bid pool.

33. A method as recited in claim 22 further determining the number of the plurality of bids in a common bid pool by an estimated time period needed to exhaust the bid pool.

34. A method as recited in claim 22 further comprising providing for the repetitive, automatic purchase by any customer of at least one bid from each of a plurality of different bid pools associated with the preselected merchandise.

35. A method as recited in claim 34 comprising associating each of the plurality of different bid pools with substantially equivalent preselected merchandise.

36. A method as recited in claim 22 requiring the payment of a commission fee by the at least one customer awarded the preselected merchandise at the reduced price.

37. A process as recited in claim 36 comprising defining the commission fee as a predetermined percentage of the monetary difference between the purchase price of the awarded merchandise and the monetary value of the total number of bids purchased by the at least one customer on the awarded merchandise.

38. A method as recited in claim 37 comprising defining the reduced price as the monetary value of the total number of bids purchased by the at least one customer for the awarded merchandise plus the commission fee.

39. A method as recited in claim 22 comprising defining the reduced price as at least the monetary value of the total number of bids purchased by the at least one customer for the awarded merchandise.

40. A method as recited in claim 39 comprising further defining the reduced price as at least the monetary value of the total number of bids purchased by the at least one customer for the awarded merchandise plus a commission fee.

41. A system of on-line merchandising at a potentially reduced price, said system comprising:
a marketplace accessible on line and comprising a merchandise collection,
a distribution format structured to award preselected merchandise of the merchandise collection to at least one of a plurality of customers,
a bid pool comprising a plurality of bids, each of said plurality of bids available for on-line purchase and representing an equal opportunity for award of the preselected merchandise, and
said distribution format further structured to award the preselected merchandise at a reduced price to one of the plurality of customers having purchased a winning bid.

42. A system as recited in claim 41 wherein said distribution format further comprises an award of the preselected merchandise to any customer having purchased a plurality of bids with a collective monetary value at least substantially equal to a purchase price of the preselected merchandise.

43. A system as recited in claim 41 wherein the reduced price of the awarded preselected merchandise is at least partially defined by the monetary value of the total number of bids purchased by the one customer for the preselected merchandise.

44. A system as recited in claim 43 wherein the reduced price is further defined by the additional payment of a commission fee.

45. A system as recited in claim 44 wherein the commission fee is defined as a pre-determined percentage of the monetary difference between the purchase price of the awarded merchandise and the monetary value of the total number of bids purchased by the at least one customer on the awarded merchandise.

46. A system of on-line merchandising comprising:
a marketplace accessible on-line and comprising a collection of preselected merchandise,
said preselected merchandise including an electronic gift card,
a distribution format structured to award preselected merchandise including said electronic gift card to at least one of a plurality of customers,
a bid pool comprising a plurality of bids each available for on-line purchase and representing an opportunity for award of said preselected merchandise, and
said distribution format further structured to award at least said electronic gift card at a reduced price to one of the plurality of customers having purchased a winning bid.

47. A system as recited in claim 46 wherein said electronic gift card is structured to represent any one of a plurality of predetermined monetary values.

48. A system as recited in claim 47 wherein said electronic gift card is structured to be commercially transacted with any of a plurality of vendors.

49. A system as recited in claim 48 wherein said commercial transaction comprises an exchange of said electronic gift card for merchandise of commensurate monetary value of any of the plurality of vendors.

50. A system as recited in claim 49 wherein said commercial transaction comprises an on-line transaction.

51. A system as recited in claim 49 wherein said commercial transaction comprises a walk-in transaction.

52. A system as recited in claim 48 wherein said commercial transaction comprises an exchange of said electronic gift card for a vendor's gift certificate of any of the plurality of vendors.

53. A system as recited in claim 52 wherein said commercial transaction comprises an on-line transaction.

54. A system as recited in claim 48 wherein said electronic gift card is structured for delivery to a recipient, said commercial transaction being conducted between the recipient and any of the plurality of vendors.

55. A system as recited in claim 54 wherein said commercial transaction comprises an on-line transaction.

56. A system as recited in claim 54 wherein said commercial transaction comprises a walk-in transaction.
